(19) United States
(12) Patent Application Publication
(10) Pub. No.: US 2008/0099070 A1
(43) Pub. Date: May 1, 2008

(54) Gasket and Seal Apparatus

(75) Inventors: Joseph A. Luongo, Walpole, MA (US); Charles Murphy, Norton, MA (US); David Friswell, Upton, MA (US); Mark W. Moeller, Kingston, MA (US); Peter Kirby, Upton, MA (US)

Correspondence Address: WATERS INVESTMENTS LIMITED;C/O WATERS CORPORATION, 34 MAPLE STREET - LG, MILFORD, MA, 01757, US

(73) Assignee: WATERS INVESTMENTS LIMITED, New Castle (DE)

(21) Appl. No.: 11/573,904

(22) PCT Filed: Aug. 24, 2005
(86) PCT No.: PCT/US05/30199

§ 371 Date: Oct. 10, 2007

Related U.S. Application Data
(60) Provisional application No. 60/604,145, filed on Aug. 24, 2004.

(51) Int. Cl. F16K 27/00

(52) U.S. Cl. 137/15.18; 251/366

(57) ABSTRACT

Embodiments of the present invention feature devices and methods for holding fluids at high pressures. One embodiment of the present invention features a fluid containing conveying device for receiving and discharging fluids. The device comprises a housing having a chamber for containing a fluid. The housing has a first gasket receiving surface for receiving a gasket. A gasket formed of a deformable material and having a first abutment surface and second abutment surface. The first abutment surface received on the first gasket receiving surface and the second abutment surface for receiving a chamber closing piece. The chamber closing piece having a second gasket receiving surface, the chamber closing piece for closing the chamber. At least one of the first gasket receiving surface of the housing and the second gasket receiving surface of the chamber closing piece having a retaining grove, having at least one edge. Compression means for compressing the gasket, deforming the material such that the gasket is pressed into retaining groove and gripped by the edge of the cavity to prevent gasket movement.

### CROSS REFERENCE TO RELATED APPLICATIONS

This application claims priority from U.S. Provisional Patent Application Ser. No. 60/604,145, filed Aug. 24, 2004. The contents of these applications are incorporated herein by reference.

### STATEMENT ON FEDERALLY SPONSORED RESEARCH N/A

Embodiments of the present invention are directed to devices and methods for coupling, or joining components for containing, receiving and discharging fluids. Devices made in accordance with the present invention have special application to fittings, valves and check valves.

### BACKGROUND OF THE INVENTION

The present invention is directed to devices for containing, receiving and discharging fluids. Devices embodying features of the present invention include, by way of example, without limitation, tees, unions, fittings, valves and check valves. These devices are sometimes placed in line between two or more conduits that are joined in the form of a union, or tee, or valve. The term “union” is used in the sense of joining or bringing together. A “tee” is a form of fitting in which fluid flow is split or combined. The devices are sometimes part of a larger structure in which the device communicates through ports or openings of a housing of such structure.

In this application, the term “fitting” will be used in the broadest sense to refer to a device that may be placed in a larger structure, for example, a pump assembly, or in line.

The term “valve” is used in a conventional manner to denote a device that can stop fluid flow in a conduit or pipe. A check valve is a special valve that allows fluid to flow in one direction only.

Fitting and valves of the prior art typically have gaskets and seals that are separate and discrete parts. These gaskets and seals exhibit material creep, cold flow, relaxation and extrusion. That is, as the fluid pressure fluctuates, the gaskets move. This movement can lead to the gasket slipping from an original position, leading to gasket or seal failure.

This movement also creates a rebound of the gasket as the pressure is released, creating a potential pressure ripple. Analytical instruments, in particular, are sensitive to the rebound and pressure ripple effect.

These problems are amplified as the pressure contained by such devices increases. Analytical instruments, such as chromatography pumps and detectors typically operate at pressures of up to 5,000 pounds per square inch (psi) for High Pressure/Performance Liquid Chromatography (HPLC) and up to 20,000 psi for extreme pressure regimes. It is desirable to have analytical instruments operate at higher pressures, however, fittings, valves and check valves have a high failure rate at pressures greater than 3,000 psi.

### SUMMARY OF THE INVENTION

Embodiments of the present invention are directed to devices and methods for containing, receiving and discharging fluids. One embodiment of the present invention directed to a device comprises a housing having a chamber for containing a fluid. The housing has a first gasket receiving surface for receiving a gasket. The device further comprises a gasket formed of a deformable material and having a first abutment surface and a second abutment surface. The first abutment surface is received on the first gasket receiving surface and the second abutment surface is for receiving a chamber closing piece. The device further comprises a chamber closing piece having a second gasket receiving surface. The chamber closing piece is for closing the chamber. At least one of the first gasket receiving surface of the housing and the second gasket receiving surface of the chamber closing piece has a retaining groove. The retaining groove having at least one edge to engage the gasket. The device further comprises compression means for compressing the gasket, deforming the material such that the gasket is pressed into the cavity and gripped by the edge of retaining groove to prevent gasket movement.

As used herein, the term “chamber” denotes the space in which fluids are held, received or discharged. For example, embodiments of the present invention are particularly suited for use in a check valve, in which case the housing is a check valve housing. The chamber may comprise any of the interior spaces in which fluid is held. Preferably, the chamber is the chamber in which the flow closing element is held, such as a ball of flap or rotary structure.

The chamber closing piece may comprise any part, component or assembly which mates to the gasket and the housing.

Preferably, at least one of the first gasket receiving surface and the second gasket receiving surface define a plane. And, the retaining groove has a recessed wall having an angle with respect to the plane of the first gasket receiving surface and the second gasket receiving surface in which it is placed. A preferred angle is in a range of 45 to 135 degrees from the plane. The retaining groove can define a “V” in the surface in which it is placed.

Preferably, the gasket receiving surface has a machined surface with a circular lay. The circular lay cooperates with the gasket and compression means to hold the gasket against movement.

Preferably the gasket is comprised of a material having a friction coefficient of at least 0.2. A preferred deformable material is a polyaryl ketone or ethelene. A preferred polyaryl ketone or ethelene is selected from the group of compositions consisting of polyetheretherketone (PEEK), polytrifluoroethylene (PTFE), polychlorotrifluoroethylene (PCTFE), perfluoroalkoxy (PFA), and fluoronated ethylenepropylene (FEP) and mixtures thereof. Preferably, the material is at least eighty percent polyetheretherketone (PEEK).

A preferred, gasket has a thickness between 0.001 and 0.005 inches. This thin gasket exhibits a small area to the chamber and fluids contained therein to limit the area that will have greater elasticity. The thickness of the gasket influences the depth of the retaining groove. Preferably, the retaining groove has a depth, and the thickness of the gasket is equal to or exceeds the depth.

Preferably, the first gasket receiving surface or second gasket receiving surface in which the cavity is placed has a first edge proximal to the chamber and a second edge distal to the chamber. The distance between the first edge and the second edge has a midpoint, and the retaining groove is at approximately the midpoint or towards the first edge to minimize pressure ripple.

A further embodiment of the device comprises a first housing having an first passage and first mounting gasket receiving surface. The first passage is for receiving or discharging fluid to a second passage in a second housing. The first mounting gasket receiving surface is for compressing a gasket against the second housing to place the first passage in fluid communication with a second opening of the second housing. The first mounting gasket receiving surface is recessed in a gasket cavity for receiving a deformable gasket. The device further comprises a second housing having a second mounting gasket receiving surface and a second passage. The second passage is for receiving or discharging fluid to the first passage in the first housing. The second monthly gasket receiving surface is for compressing a gasket against the first mounting gasket receiving surface of the first housing to place the second passage in fluid communication with the first passage. The device further comprises a gasket having a thickness and constructed and arranged to be received in the gasket cavity with at least five to twenty five percent of the thickness of the gasket protruding from the cavity in an unloaded position. And, the device comprises compression means to press the first housing and second housing together to compress said gasket to make a fluid connection between said first opening and said second opening.

Upon compression by compression means, the gasket has, approaching none to five percent and most preferably one percent or less, of the height protruding. The mass of the gasket is directed, preferably, into a deformed gasket receiving area of the gasket cavity. The deformed gasket receiving area of the gasket cavity does not contain gasket in the unloaded position, that is, non-compressed state. Thus, the gasket is not directed out between the coupling surfaces but into the cavity. The deformed material of the gasket is more elastic and more likely to contribute to pressure ripple.

A preferred cavity has a trapezoid shape. The trapezoid has acute angles at the base to form the gasket receiving area. The gasket is held by the edges of the cavity.

The gasket has a height under compression and a height without compression. Preferably, the height under compression 15 to 30% of the height without compression. The gasket has a total surface area, an unloaded surface area exposed to non gasket receiving surfaces and a loaded surface area exposed to non-gasket receiving surfaces. The loaded surface have a range approaching zero to 5% of the total surface area and an unloaded surface area have a range of approximately 6 to 11% of the total surface area of the gasket.

Preferably, the material is a polyaryl ketone or ethelene. Preferred polyaryl ketones and ethelenes are selected from the group of compositions consisting of polyetheretherketone (PEEK),polytrifluoroethylene (PTFE), polychlorotrifluoroethylene (PCTFE), perfluoroalkoxy (PFA), and fluoronated ethylenepropylene (FEP) and mixtures thereof.

Embodiments of the present invention are ideally suited for applications wherein the first housing is a valve housing, and, in particular, a check valve. These valves are placed in pumps wherein the second housing is a pump housing.

In such applications, compression means comprises a screw fitting and cooperating thread on a pump housing. The first housing is coupled to the screw fitting and the second housing has cooperating threads to receive the screw fitting. The screw fitting is rotated with respect to the second housing, which upon tightening, compresses the gasket.

Device of the present invention are capable of containing and conveying fluid under pressure greater than 5,000 psi.

Further embodiments of the present invention are directed to a method of making the device and using the device as described.

These and other features and advantages will be apparent to those skilled in the art upon viewing the drawings and reading the detailed description that follows.

### BRIEF DESCRIPTION OF THE DRAWINGS

FIG. 1 depicts, in cross section, a side view of a device made in accordance with the present invention; and

FIG. 2 depicts, in cross section, a side view of a device made in accordance with the present invention; and

FIG. 3 depicts, in cross section, a close up view of a V groove on the cavity of a gasket receiving surface of chamber closing piece of a device made in accordance with one of the embodiments of the present invention; and

FIG. 4 depicts, in cross section, a close up view of a recessed cavity on the coupling surface of a device made in accordance with one of the embodiments of the present invitation.

### DETAILED DESCRIPTION OF THE INVENTION

Embodiments of the present invention will now be described with respect to the Figures, with the understanding that the Figures and the description are directed to the preferred embodiments of the present. Embodiments of the present invention have particular utility as valves and connectors. However, embodiments of the present invention have application with respect to any fluid conveying or containing device operating under pressure.

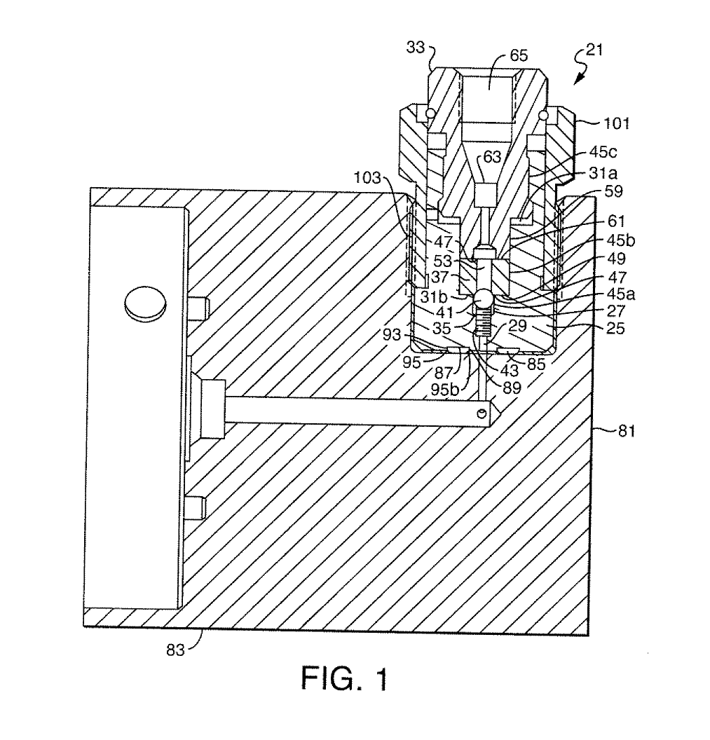

Referring now to FIG. 1, a device, generally designated by the numeral 21, embodying features of the present invention is depicted. The device comprises the following major elements: a housing 25 having a chamber 27, at least one gasket (two are depicted) 31a and 31b, compression means 33 and closing piece 37.

The device 21 is in the nature of a valve and has a check valve assembly comprising a ball 41 and spring 43. Those skilled in the art will recognize that other valve assemblies may be substituted for the ball 41 and the spring 43. For example, the valve assembly may comprise a stator and rotor of a rotating valve, plunger and seat assembly or swinging flap [not shown]. The ball 41 and the spring 43 are constructed and arranged in chamber 27 to operate in a conventional manner. That is, the ball 41 and spring 43 allow the flow of fluid in a single direction.

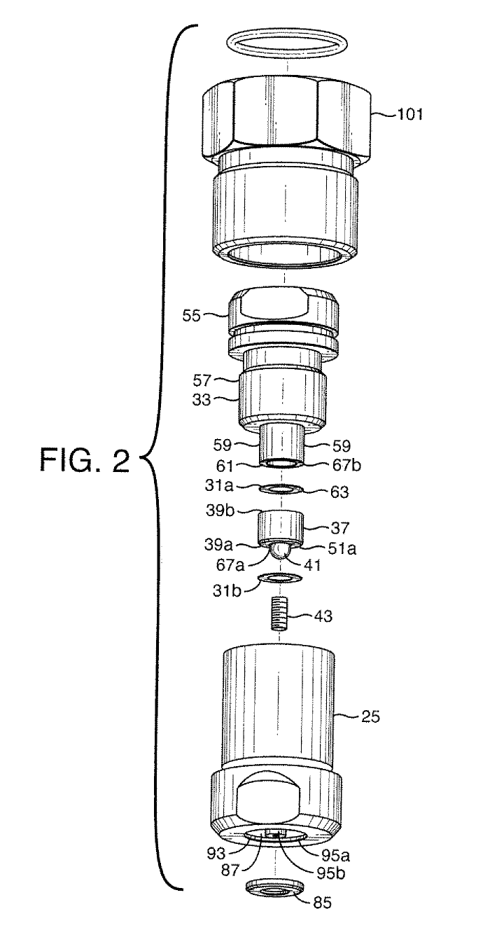

Housing 25 has a first interior wall 45a, cylindrical in form, that defines chamber 27. As best seen in FIG. 2, he housing 25 has a housing gasket receiving surface 49 extending radially outward forming an edge 47. Housing 25 has a second interior wall 45b, cylindrical in form, having a larger diameter than the first interior wall 45a that defines a cavity to retain the chamber closing piece 37. And, housing 25 has a third interior wall 45c, cylindrical in form, that defines a cavity to retain, in whole or in part, the compression means 33. A passage 29 allows the chamber 27 to be placed in fluid communication with the exterior of the housing.

The closing piece 37 is cylindrical in shape to cooperate and fit within the second interior wall 45b. As best seen in FIG. 2, the closing piece 37 has a first closing piece gasket receiving surface 39a and a second closing piece gasket receiving surface 39b. Housing gasket receiving surface 49 and first closing piece gasket receiving surface 39a receive a first gasket 31a interposed there between. Returning now to FIG. 1, closing piece 37 has an opening 53 to allow fluid to exit the chamber 27.

Compression means 33 may take several forms. As illustrated, compression means 33 comprises a screw fitting 55 having a fitting first wall 57. Preferably, fitting first wall 57 and housing third wall 45c have cooperating threads such that relative rotation of the screw fitting 55 and housing 25 moves the screw fitting within the cavity of the housing third wall 45c.

Screw fitting 55 has a compression post 59, cylindrical in formed and constructed and arranged to cooperate and fit within the second interior wall 45b of the housing 25. The compression post 59 has a post gasket receiving surface 61 for receiving second gasket 31b. Screw fitting 55 has an axial fitting opening 63 allowing fluid communication with the chamber 27 upon opening of the check valve assembly 35. Fitting opening 63 has an expanded section 65 for receiving a fluid coupling [not shown] comprising tubing or conduits and appropriate connecting fitting known in the art.

First and second gaskets 31a and 31b are formed of a deformable material such as soft metals or plastic. A preferred material is a polyaryl ketone or ethylene. One particularly preferred material is comprised of at least 80% polyetheretherketone (PEEK). Preferably, gaskets 31a and 31b are comprised of a material having a friction coefficient of at least 0.2.

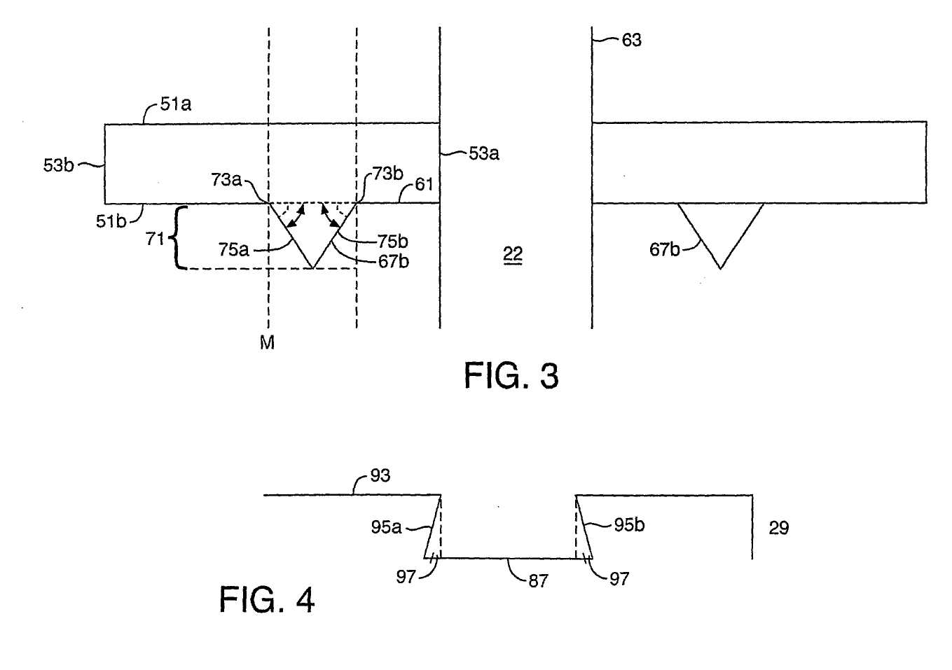

Preferably, turning now to FIG. 3, gaskets 31a and 31b present a thin profile to high pressure fluids. That is, first gasket 31a and second gasket 31b have a first planar surface 51a and a second planar surface 51b. An inner wall 53a defines an opening, to cooperate with opening 53 in the closing piece 37, and opening 63 in the screw fitting 55, and an outer wall 53b. The inner wall 53a and outer wall 53b are cylindrical with an axial length dimension defining the thickness of each gasket 31a and 31b. A preferred thickness is 0.001 to 0.005 inches.

First and second gaskets 31a and 31b have a gasket stress factor of two to four times the anticipated fluid pressure to which the gaskets will be subjected. The term “gasket stress factor” is used to denote the multiplying factor between the contact stress pressure (i.e., the compression on the components of the fitting) versus the fluid pressure of the liquid flowing in the fitting. This relationship can be described in the following formula:

Contact stress pressure =fluid pressure X gasket stress factor.

The contact stress pressure is preferably greater than the anticipated fluid pressure. The present invention has particular utility for conveying or containing fluids at pressures up to approximately 15,000 psi.

The thickness of the gaskets 31a and 31b is selected to cooperate with gasket retaining recesses carried on one or more gasket receiving surfaces selected from housing gasket receiving surface 49, closing piece gasket receiving surfaces 51a and 51b and post gasket receiving surface 61. Preferably, at least one of opposing gasket retaining surface, such as housing gasket retaining surface 49 and closing piece gasket receiving surface 51a, on one hand, and closing piece gasket receiving surface 51b and post gasket receiving surface 61, on the other, has a retaining groove. As best seen in FIG. 2, closing piece gasket retaining surface 51a and post gasket retaining surface 61 each have a retaining groove 67a and 67b.

Turning now to FIG. 3 which illustrates a gasket receiving surface, such as post gasket receiving surface 61, in cross section, a retaining groove 67b is depicted. The retaining groove 67b may take several forms of which one is described in FIG. 3. The retaining groove 67a, depicted in FIG. 2, is consistent with the retaining groove 67b depicted in FIGS. 3.

The retaining groove 67b has a depth 71 measured from the top of the post gasket receiving surface 61. Preferably, the thickness of the gasket 31a received on the post gasket receiving surface 61 is equal to or greater than the depth 71 of the retaining groove 67b.

The retaining groove 67b in FIG. 3 is triangular in cross section with two edges 73a and 73b. The triangle form of retaining groove 67a depicted in FIG. 3 has two descending walls 75a and 75b.

The edges 73a and 73b have an angle measured from the plane of the post gasket receiving surface 61 to the descending walls 75a and 75b. Preferably, the angle is 35 to 135 degrees. The edges 73a and 73b are pressed into the gasket 31a and prevent movement and creep of the gasket 31a during pressure cycles.

As best seen in FIG. 3, the retaining groove 67b is at a position proximal to axial fitting opening 63. In a similar manner, the retaining groove 67a is at a proximal position with respect to chamber 27. That is, the gasket receiving surface 61 has a midpoint as denoted by dotted line M, and the retaining groove 67b is positioned between the midpoint and the opening 63. Thus, the retaining groove 67b is in a position to grip the gasket 31b to prevent creep.

The gasket receiving surfaces comprising housing gasket receiving surface 49, closing piece gasket receiving surfaces 51a and 51b and post gasket receiving surface 61 have a circular lay. Those skilled in the art of machining will understand that a circular lay refers to machining with a circular motion around the center of the piece. The circular lay produces small grooves [not shown] which further grip the gasket 31a or 31b.

Turning now to FIG. 1, device 21 is secured to a second housing 81 of a pump 83. Device 21 has a mounting gasket 85. Mounting gasket 85 is fitted and received on a first mounting gasket surface 87 of housing 25 and a second mounting gasket surface 89 of second housing 81. Those skilled in the art will recognize second housing 81 may be associated with a pump 83 as illustrated or other fittings, hardware, detectors and the like.

Device 21 has a passage 29 in communication with chamber 27 and extending through the first mounting gasket surface 87. Passage 29 is in fluid communication with a pump passage 91 to receive fluid under pressure and allow such fluid to enter chamber 27.

Device 21 has an end wall 93 having a planar surface and recess walls 95a and 95b which cooperate to partially contain mounting gasket 85 on mounting gasket surface 87. Gasket 85 is deformable. Under conditions of no compression, mounting gasket 85 will have an at rest inner and outer radius and under conditions of compression, the mounting gasket will have a load inner and outer radius. Similarly, under condition of compression, the mounting gasket will exhibit an at rest thickness and under load it will exhibit a load thickness. Preferably, the mounting gasket has a thickness such that under compression, 5 to 25% of the gasket mass is forced out beyond the recess wall 95 inner and outer at rest radius. Under compression, the thickness under compression is 15 to 30 percent of the thickness without compression. The mounting gasket 85 has a loaded surface area and an unloaded surface area. The loaded surface area has a range approaching zero to 5 percent of the total surface area and unloaded surface area of 6 to 11 percent of the total surface area.

Turning now to FIG. 4, such Figure depicts housing 25 in cross section at the mounting gasket receiving surface. The recess wall 95 define a trapezoid in which the radius about the mounting gasket receiving surface 87 is greater than the radius of the recess wall 95a at the end wall 93. The recess wall 95b has a radius about the gasket receiving surface 87 that is less then the radius of the recess wall 93b at the end wall 93. A triangular area bounded by a line perpendicular to the end wall 93 and the recess wall 95 defines a loaded gasket cavity 97 for receiving the expansion of the mounting gasket 85 with approximately five to twenty five percent of the gasket thickness protruding from the recess. That is, the end wall 93 approaches, but does not meet and contact second housing 81. The loaded gasket cavity 97 is constructed and arranged to accommodate approximately 0.01 to 0,5% of the gasket volume and preferably, 0.1 to 0.2%. For example, where the total gasket volume is 6.791×10⁻³ cubic inches, the loaded gasket cavity is sized to a volume of 1.016×10⁻⁵ cubic inches. Recess wall 95 secures the mounting gasket 85 against creep.

The mounting gasket 85 is made of a polymeric plastic material such as, polyaryl ketone or ethelene. Preferred polyaryl ketones and ethylenes are selected from the group consisting of polyetheretherketone (PEEK), polytrifluoroethylene (PTFE), polychlorotrifluoroethylene (PCTFE), and perfluoroalkoxy (PFA) and fluoronated ethylenepropylene (FEP) and mixtures thereof. The non-gasket components are made of metal. A preferred metal is stainless steel.

Turning now to FIG. 1 and 2 the device 21 has mounting gasket compression means in the form of a compression sleeve 101. Compression sleeve 101 has inner and outer threads [not shown] in the manner known in the art. The inner threads cooperate with threads on the housing 25 [not shown] to secure the housing 25 to the compression sleeve 101. The outer threads cooperate with threads [not shown] in the cavity 103 of the second housing 81 of pump 83. Relative rotation of the compression sleeve 101, housing 25 and the second housing 81 compresses and secures device 21 to the pump 83. Those skilled in the art will readily recognize that other compression means other than cooperation treads may be used to secure housing 25 to a second housing 81 such as sleeves equipped with cams, screws or other securing devices.

The operation of the device 21 is exemplified in the method of making and using device 21. Turning now to FIG. 2, the mounting gasket 85 is secured on mounting gasket receiving surface 85 of housing 25. Check valve assembly 35 is placed in chamber 27. Gasket 31a is placed on housing gasket retaining surface 49. Chamber closing piece 37 is placed into the housing 25 with closing piece gasket receiving surface 51a on gasket 31a. Second gasket 31b is placed on closing piece gasket receiving surface 51b followed by screw fitting 33 with post gasket receiving surface 61 on gasket 31b. Rotation of the screw fitting 33 with respect to the housing 25 compresses the gaskets 31a and 31b which are held in place by the circular lay of the gasket receiving surfaces and the retaining grooves 67a and 67b. Compression sleeve 101 is secured to the housing 25 by cooperating threads [not shown].

Turning now to FIG. 1, the device 21 is secured to the cavity 103 of pump 83 by cooperating threads [not shown] on the compression sleeve 101 and cavity 103. Rotation of the compression sleeve 101 with respect to the cavity 103 compresses the mounting gasket 85 and forces the mounting gasket into the loaded gasket cavity 97. The check valve assembly allow fluid movement in one direction through chamber 27.

The device 21 may withstand pressures of up to 15,000 psi. Thus, the devices and methods of the present invention are ideally suited for high pressure applications. Devices made in accordance with the present invention do not exhibit material creep, cold flow relaxation and extrusion. That is, as the fluid pressure fluctuates, the gaskets do not move significantly from the original position. Thus, embodiments of the present invention provide devices which exhibit resistance to gasket failure.

These features and advantages have been described with respect to the drawings and detailed description which describe preferred embodiments of the present invention. Those skilled in the art will recognize that the present invention can be altered and modified with out departing from the teaching herein. And, the present should not be limited to the precise details but should encompass the subject matter of the following claims and equivalents thereto.

What is claimed:

1. A device for holding or conveying a fluid comprising:
a housing having a chamber for containing a fluid and a first gasket receiving surface for receiving a gasket,
a gasket formed of a deformable material received on said first gasket receiving surface and said second abutment surface for receiving a chamber closing piece;
a chamber closing piece having a second gasket receiving surface, said chamber closing piece for closing the chamber; at least one of said first gasket receiving surface of said housing and said second gasket receiving surface of said chamber closing piece having a retaining groove, said retaining groove having at least one edge; and,
compression means for compressing the gasket, deforming the material such that the gasket is pressed into said retaining groove and gripped by the edge to prevent gasket movement.

2. The device of claim 1 wherein said housing is a check valve housing.

3. A device of claim 1 wherein said at least one of said first gasket receiving surface and said second gasket receiving surface define a plane and said retaining groove has a descending wall having an angle with respect to said plane in a range of 45 to 135 degrees.

4. The device of claim 1 wherein said gasket is comprised of a material having a friction coefficient of at least 0.2.

5. The device of claim 1 wherein said gasket receiving surface has a machined surface with a circular lay.

6. The device of claim 1 wherein said deformable material is a polyaryl ketone or ethelene.

7. The device of claim 1 wherein said material is at least eighty percent polyetheretherketone (PEEK).

8. The device of claim 1 wherein said retaining groove is a “V”.

9. The device of claim 1 wherein said gasket has a thickness between 0.001 and 0.005 inches.

10. The device of claim 1 where said gasket has a thickness and said retaining groove has a depth, and said thickness is equal to or exceeds said depth.

11. The device of claim 1 wherein said first gasket receiving surface and second gasket receiving surface having said retaining groove have a first edge proximal to said chamber and a second edge distal to said chamber and the distance between said first edge and said second edge has a midpoint, and said retaining groove is at approximately said midpoint or towards said first edge to minimize pressure ripple.

12. A device for containing or conveying fluids comprising:
a housing having a first passage, end wall, recess wall and first mounting gasket receiving surface, said first passage opening for receiving or discharging fluid to a second passage in a second housing, said mounting gasket receiving surface for compressing a gasket against said second housing to place said first passage in fluid communication with a second passage of said second housing, said end wall defining an end of said housing and defining a plane, said recess wall extending into said housing from said end wall and terminating in said first mounting gasket receiving surface to define a gasket cavity, said first coupling surface having a gasket cavity for receiving a deformable gasket, said cavity recessed in said first coupling surface surrounding in spaced relationship said first opening and having a depth;
a second housing having a second gasket receiving surface and a second passage, said second passage for receiving or discharging fluid to said first passage in said first housing, said second gasket receiving surface for compressing a gasket against said first mounting gasket receiving surface of said first housing to place said second passage in fluid communication with said first passage;
a gasket having a thickness and constructed and arranged to be received in said gasket cavity with at least ten percent of the thickness of said gasket protruding from said cavity; and,
compression means to press said first housing and second housing together to compress said gasket to make a fluid connection between said first passage and said second passage.

13. The device of claim 12 wherein said material is a polyaryl ketone or ethelene.

14. The device of claim 13 wherein said polyarly ketone or ethelene is selected from the group of compositions consisting of polyetheretherketone (PEEK),polytrifluoroethylene (PTFE), polychlorotrifluoroethylene (PCTFE), perfluoroalkoxy (PFA), and fluoronated ethylenepropylene (FEP) and mixtures thereof.

15. The device of claim 12 wherein said first housing is a valve housing.

16. The device of claim 12 wherein said second housing is a pump housing.

17. The device of claim 15 wherein said compression means comprises a compression sleeve having cooperating thread, said first housing is coupled to said compression sleeve and said second housing is a pump housing having cooperating threads to receive said compression sleeve, which upon tightening compresses said gasket.

18. The device of claim 12 wherein fluid under pressure greater than 5,000 psi is transported between said first opening and said second opening.

19. The device of claim 12 wherein said gasket has a height under compression and a height without compression, said height under compression 15 to 30% of the height without compression.

20. The device of claim 12 wherein said gasket has a total surface area, and an unloaded surface area and a loaded surface area, said loaded surface having a range approaching zero to 5% of the total surface area and an unloaded surface area of approximately 6to 11%.

21. A method of sealing a first housing to and second housing comprising the steps of providing:
a first housing having an first passage end wall, recess wall and mounting gasket receiving surface, said first passage for receiving or discharging fluid to a second passage in a second housing, said mounting gasket receiving surface for compressing a gasket against said second housing to place said first passage in fluid communication with a second passage of said second housing, said end wall defining as end of said housing and a plane, said recess wall extending into said housing and terminating in said first mount gasket receiving surface to define a gasket cavity, said gasket cavity for receiving a deformable gasket, having deformed gasket material area;
a second housing having a second mounting gasket receiving surface and a second passage, said second passage for receiving or discharging fluid to said first passage in said first housing, said second mounting gasket receiving surface for compressing a gasket against said first mounting gasket receiving of said first housing to place said second opening in fluid communication with said first passage;
a gasket having a thickness and constructed and arranged to be received in said gasket cavity with at least five to ten percent of the thickness of said gasket protruding from said cavity in an unloaded position with said deformed gasket material area unoccupied and a loaded position in which said thickness is less than said unloaded position and said deformed gasket material area occupied by said gasket; and,
using compression means to press said first housing and second housing together to compress said gasket to make a fluid connection between said first passage and said second passage.

22. A method of holding or conveying a fluid comprising the steps of providing a device having:
a housing having a chamber for containing a fluid and a first gasket receiving surface for receiving a gasket,
a gasket formed of a deformable material received on said first gasket receiving surface and piece;
a chamber closing piece having a second gasket receiving surface, said chamber closing piece placed on said gasket for closing the chamber; at least one of said first gasket receiving surface of said housing and said second gasket receiving surface of said chamber closing piece having a retaining groove, said cavity having at least one retaining groove edge; and,
compression means for compressing the gasket, deforming the material such that the gasket is pressed into said retaining groove and gripped by the edge of to prevent gasket movement.
